(19) United States
(12) Patent Application Publication
(10) Pub. No.: US 2025/0392142 A1
(43) Pub. Date: Dec. 25, 2025

(54) METHOD AND APPARATUS FOR VOLTAGE FOLDBACK AND CURRENT FOLDBACK

(71) Applicant: MILWAUKEE ELECTRIC TOOL CORPORATION, Brookfield, WI (US)

(72) Inventors: Jacob M. Lamb, Jackson, WI (US); Mahashree Saravanan, Pewaukee, WI (US); Matthew J. Ragbir, Wauwatosa, WI (US); Zhenyu Ye, Menomonee Falls, WI (US)

(21) Appl. No.: 19/247,949

(22) Filed: Jun. 24, 2025

Related U.S. Application Data
(60) Provisional application No. 63/664,044, filed on Jun. 25, 2024.
(60) Provisional application No. 63/817,875, filed on Jun. 4, 2025.

(51) Int. Cl. H02J 7/00

(52) U.S. Cl. CPC H02J 7/00304; H02J 7/007182; H02J 7/007194

(57) ABSTRACT

An electronic device including a power output, a power source, configured to provide a voltage. A device may include a current sensor configured to measure the output current. A device may include a power switching network electrically connected between the power source and the power output. A device may include a controller electrically connected to the current sensor and the power switching network, the controller configured to: determine, using the current sensor, the output current. A device may include compare the output current to a predetermined load current threshold, determine a voltage limit of the voltage of the power source as a function of the difference between the output current and the predetermined load current threshold, and control the output current to drive the load, via the power switching network, based on the voltage limit.

### RELATED APPLICATIONS

This application claims the benefit of U.S. Provisional Patent Application No. 63/664,044, filed Jun. 25, 2024, and U.S. Provisional Patent Application No. 63/817,875, filed Jun. 4, 2025, the entire content of each of which is hereby incorporated by reference.

### FIELD

Embodiments described herein relate to a device for current limit based voltage foldback and current foldback.

### SUMMARY

In some aspects, the techniques described herein relate to an electronic device including: a power output; a power source; a power switching network electrically connected between the power source and the power output; a current sensor configured to measure an output current provided at the power output; and a controller electrically connected to the current sensor and the power switching network, the controller configured to: determine, using the current sensor, the output current, compare the output current to a predetermined current threshold, modify a voltage limit at the power output when the output current exceeds the predetermined current threshold, and control, using the power switching network, power provided at the power output based on the modified voltage limit.

In some aspects, the techniques described herein relate to an electronic device, wherein the controller is further configured to control the voltage limit when the output current is greater than or equal to the predetermined current threshold.

In some aspects, the techniques described herein relate to an electronic device, wherein the controller is configured to control the voltage limit at a fold rate.

In some aspects, the techniques described herein relate to an electronic device, wherein the controller is configured to increase the voltage limit at an unfold rate when the voltage limit is below a maximum voltage limit for the electronic device and the output current is less than the predetermined current threshold.

In some aspects, the techniques described herein relate to an electronic device, wherein the fold rate the unfold rate are asymmetrical.

In some aspects, the techniques described herein relate to an electronic device including: a battery system; and a controller electrically connected to the battery system and configured to: determine a voltage of the battery system, determine a modification factor based on a modification rate and a difference between the voltage and a voltage limit, set a current limit based on the modification factor and a discharge current, and operate the electronic device based on the current limit.

In some aspects, the techniques described herein relate to an electronic device, wherein the controller is further configured to: receive a requested current, determine a temperature of the battery system, set the requested current as the discharge current when the temperature is above a temperature threshold, and set a designed discharge current as the discharge current when the temperature is below the temperature threshold.

In some aspects, the techniques described herein relate to an electronic device, wherein the controller is further configured to: set a fold rate as the modification rate when the difference between the voltage and the voltage limit is greater than zero, and set an unfold rate as the modification rate when the difference between the voltage and the voltage limit is less than or equal to zero.

In some aspects, the techniques described herein relate to an electronic device, wherein the fold rate and the unfold rate are asymmetric.

In some aspects, the techniques described herein relate to an electronic device, wherein the controller is further configured to set the modification factor to higher of a modification limit and a product of the modification rate and the difference between the voltage and the voltage limit.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIGS. 1A and 1B are perspective views of examples of an electronic device, according to some embodiments.

FIG. 2 is simplified block diagram of the electronic device of FIGS. 1A and 1B, according to some embodiments.

FIG. 3 is a simplified block diagram of a control system of the electronic device of FIG. 2, according to some embodiments.

FIG. 4 is a graphical representation of voltage and current during an experimental operation of the electrical device of FIG. 2 when not using the voltage feedback techniques described herein, according to some embodiments.

FIGS. 5A and 5B are a graphical representation of voltage and current during an operation of the electrical device of FIG. 2 when not using the voltage feedback techniques described herein, according to some embodiments.

FIG. 6 is a graphical representation of voltage and current during an operation of the electrical device of FIG. 2 when not using the voltage feedback techniques described herein, according to some embodiments.

FIG. 7 is a graphical representation of voltage and current during an operation of the electrical device of FIG. 2 when not using the voltage feedback techniques described herein, according to some embodiments.

FIGS. 8A and 8B are a graphical representation of voltage and current during an operation of the electrical device of FIG. 2 when not using the voltage feedback techniques described herein, according to some embodiments.

FIG. 9 illustrates a block diagram of a control system of the electronic device of FIG. 2, according to some embodiments.

FIG. 10 illustrates an expanded block diagram of the control system of the electronic device of FIG. 2, according to some embodiments.

FIGS. 11A and 11B are a graphical representation of operating parameters during an operation of the electronic device of FIG. 2 using the control system of FIG. 9, according to some embodiments.

FIG. 12 is a flow chart illustrating a method for current limit based voltage foldback in the electronic device of FIG. 2, according to some embodiments.

FIG. 13 is a block diagram of a control system of the electronic device of FIG. 2, according to some embodiments.

FIG. 14 is a graphical representation of performance of a current foldback operation of the electronic device of FIG. 2, according to some embodiments.

FIG. 15 is a graphical representation of performance of a current foldback operation of electronic device of FIG. 2, according to some embodiments.

FIG. 16 is a graphical representation of performance of a current foldback operation of the electronic device of FIG. 2, according to some embodiments.

FIG. 17 is a graphical representation of performance of a current foldback operation of the electronic device of FIG. 2, according to some embodiments.

FIG. 18 is a flow chart illustrating a method for current foldback in the electronic device of FIG. 2, according to some embodiments.

### DETAILED DESCRIPTION

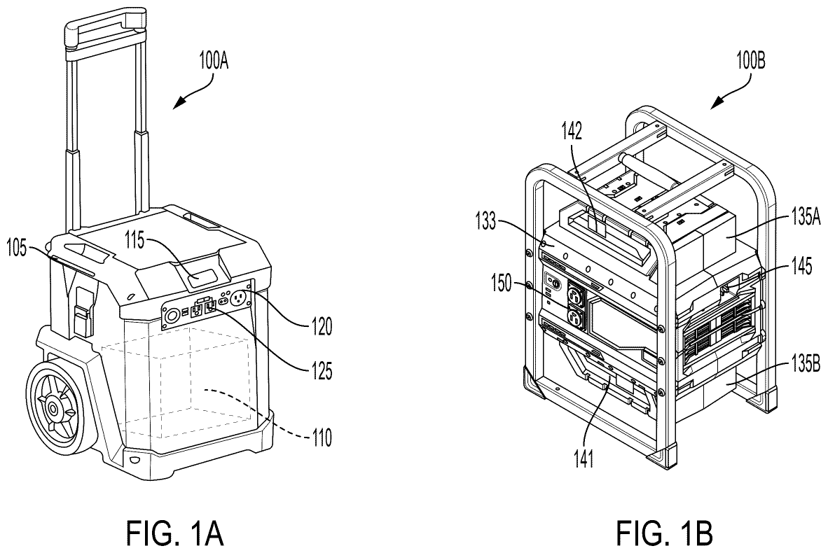

FIG. 1A illustrates an example electronic device in the form of a portable power source 100A. The portable power source 100A, also referred to as an electronic device 100, includes a housing 105 for housing an internal battery module 110 (e.g., a power source). The housing 105 also includes an input/output panel 115. The input/output panel 115 includes a power input 120 and a power outlet 125 (e.g., a power output). The power input 120 is a connection interface to connect to a power cord that is plugged into a wall outlet. The power outlet 125 is, for example, an AC outlet for powering AC powered electronic devices. The internal battery module 110 corresponds to a battery system. The portable power source 100A may include additional components other than those described and illustrated herein. For example, the portable power source 100A may include additional power outlets 125 (e.g., both AC and DC), a display, and the like.

FIG. 1B illustrates an example electronic device in the form of a portable power source 100B. The portable power source 100B, also referred to as an electronic device 100, includes a housing 133 having a first battery interface 135A and a second battery interface 135B (e.g., a power source). The first battery interface 135A and the second battery interface 235B receive a first removable power tool battery pack 141 and a second removable power tool battery pack 142 respectively. The first removable power tool battery pack 141 and the second removable power tool battery pack 142, referred singularly as a removable power tool battery pack, are for example, lithium-ion power tool battery packs having a nominal voltage of 12 Volts, 18 Volts, 24 Volts, 36 Volts, 54 Volts, 72 Volts, 90 Volts, 108 Volts, or the like. The removable power tool battery pack may be used to power cordless indoor and outdoor power tools when removed from the battery interfaces 135A, 135B. The portable power source 100B also includes a power input 145 and a power outlet 150. The power input 145 is a connection interface to connect to a power cord that is plugged into a wall outlet. The power outlet 150 is, for example, an AC outlet for powering AC electronic devices.

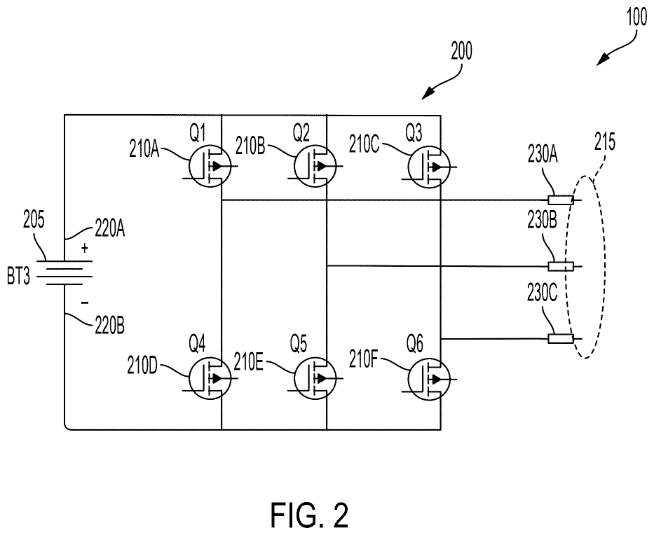

FIG. 2 illustrates a simplified block diagram of the electronic device 100 including a power switching network 200 connected between a power source 205 and a power output 215. The power source 205 is, for example, the internal battery module 110, the battery packs 141, 142, a rectified AC input, or the like and is represented by a battery stack, which includes a plurality of battery cells (e.g., Li-ion based battery cells) that are connected in series, parallel, and/or series-parallel configurations. In the example illustrated, the power switching network 200 includes six switches provided in an inverter bridge configuration. In other examples, the power switching network 200 may take a different form, for example, an H-bridge, or the like to provide a different AC output. The switches include three high-side switches 210A, 210B, 210C electrically connected between a positive terminal 220A of the power source 205 and the power output 215. The switches also include three low-side switches 210D, 210E, 210F electrically connected between a negative terminal 220B of a power source 205 and the power output 215. The plurality of switches 210A-F are controlled by a controller using a gate driver to convert DC power from the power source 205 to AC power at the power output 215. A load may be connected to the power output (e.g., power outlet 125 of FIG. 1A and power outlet 150 of FIG. 1B) of the electronic device 100.

In one example, the plurality of switches 210A-F include metal oxide semiconductor field effect transistors (MOSFETs). In another example, the plurality of switches 210A-F include wide bandgap semiconductor FETs, e.g., Gallium Nitride (GaN) and/or Silicon Carbide (SiC) based FETs. In yet another example, the plurality of switches 210A-F may include a combination of MOSFETs and wide bandgap semiconductor FETs. The power switching network 200 may include one or more sensors 230A, 230B, 230C (e.g., current sensor or voltage sensor) electrically connected to the power switching network 200 to measure an output current and/or an output voltage at the power output 215. In some instances, the sensors 230A-C each measure a different leg of the inverter bridge configuration. In some examples, only one sensor is used in the power switching network 200, for example, on the input side.

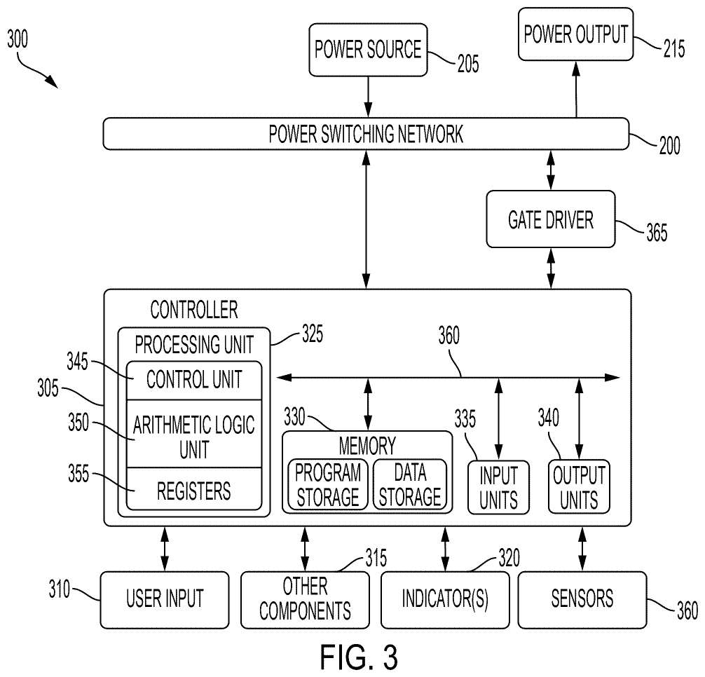

FIG. 3 illustrates a control system 300 for the electronic device 100. The control system may be part of or otherwise connected to a printed circuit board (“PCB”) and includes an electronic controller 305. The electronic controller 305 is electrically and/or communicatively connected to a variety of modules or components of the electronic device 100. For example, the illustrated electronic controller 305 is connected to the power switching network 200, sensors 360, a user input 310, a gate driver 365, other components 315 (e.g., a battery pack fuel gauge, work lights [e.g., LEDs], current/voltage sensors, etc.), and one or more indicators 320 (e.g., LEDs). The sensors 360 include, for example, the one or more sensors 230A-C shown in FIG. 2. The controller 305 provides control signals to the gate driver 365 and the gate driver 365 generates pulse width modulated (PWM) signals for the power switching network 200 based on the control signals. The controller 305 controls the power switching network 200 using the gate driver 365. In some examples, the gate driver is integrated with the controller 305.

The electronic controller 305 includes combinations of hardware and software that are operable to, among other things, control the operation of the electronic device 100 as further described below. In some embodiments, the electronic controller 305 includes a plurality of electrical and electronic components that provide power, operational control, and protection to the components and modules within the electronic controller 305 and/or electronic device 100. For example, the electronic controller 305 includes, among other things, a processing unit 325 (e.g., a microprocessor, a microcontroller, or another suitable programmable device), a memory 330, input units 335, and output units 340. The processing unit 325 includes, among other things, a control unit 345, an arithmetic logic unit (“ALU”) 350, and a plurality of registers 355 (shown as a group of registers in FIG. 3) and is implemented using a known computer architecture (e.g., a modified Harvard architecture, a von Neumann architecture, etc.). The processing unit 325, the memory 330, the input units 335, and the output units 340, as well as the various modules connected to the electronic controller 305 are connected by one or more control and/or data buses. The control and/or data buses are shown generally in FIG. 3 for illustrative purposes. The use of one or more control and/or data buses for the interconnection between and communication among the various modules and components would be known to a person skilled in the art in view of the embodiments described herein.

The memory 330 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 325 is connected to the memory 330 and executes software instructions that are capable of being stored in a RAM of the memory 330 (e.g., during execution), a ROM of the memory 330 (e.g., on a generally permanent basis), or another non-transitory computer readable medium such as another memory or a disc. Software included in the implementation of the electronic device 100 can be stored in the memory 330 of the electronic controller 305. The software includes, for example, firmware, one or more applications, program data, filters, rules, one or more program modules, and other executable instructions. The electronic controller 305 is configured to retrieve from memory and execute, among other things, instructions related to the control of the electronic device 100 described herein. In other constructions, the electronic controller 305 includes additional, fewer, or different components.

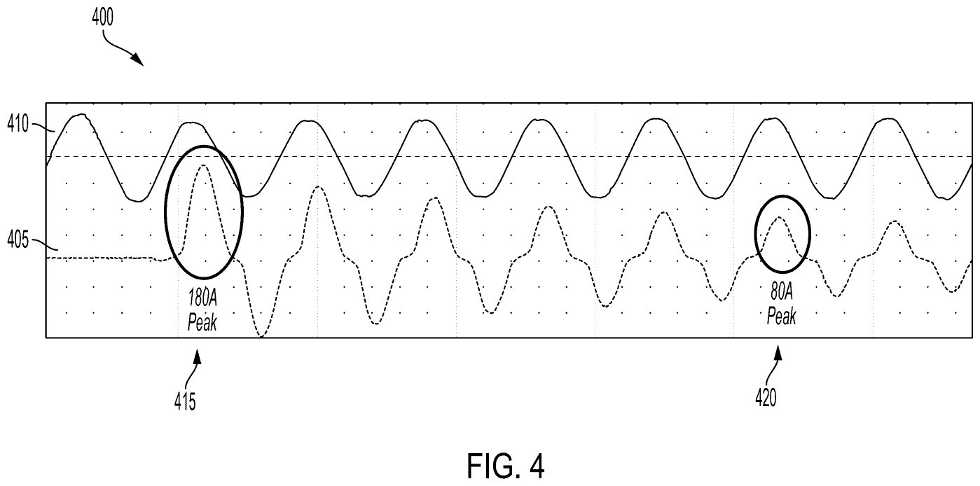

FIG. 4 illustrates a graph 400 of a voltage and current during an operation of the electronic device 100 without using the voltage foldback techniques as described herein. The output current may vary over time or work performed. For instance, many power tools draw high current under heavy operating load, and a standard power grid or battery pack may not be able to support these high current load spikes. In such instances, the grid breaker/outlet may trip, halting the use of the connected power tool and requiring a breaker reset, or an internal current limit may be reached, preventing optimal operation of the power tool. For example, a power tool, such as a miter saw, may include operating on tough or dense workpieces. Additionally, such a power tool may have a high initial load as the blade begins rotating or contacts the workpiece. This heavy load results in a rapid rise in current caused by a saw blade of the miter saw engaging the workpiece. In some existing systems, the high current load spike results in tripping a fuse or grid breaker, shutting down the saw blade and halting work on the workpiece until the fuse or breaker is reset. When the miter saw is connected to a portable power supply, an internal fuse or current limit may be breached, causing a similar shutdown of the power tool.

In graph 400, a load current 405 is contrasted with a grid voltage 410 over time. As illustrated in the graph 400, the load current 405 includes an initial current 415 of 180 Amps. In some instances, the initial current 415 corresponds with an inrush current during start-up operation of the power tool. Inrush current, also referred to as a starting current or switch-on surge, refers to the sudden, brief spike in current that occurs when a device is powered on. For example, some power tools, such as miter saws, may experience a large in-rush current during start-up. The magnitude of the inrush current may depend upon factors such as a power tool power rating, motor design, and/or the presence of soft-start or inrush current limiting features. In such instances, the inverter used must accommodate for these transient currents. The graph 400 also illustrates the nominal current 420 of approximately 80 Amps. As can be seen, the initial current 415 may be significantly higher than nominal current 420.

Without providing a solution to the initially high current draw, the associated device may trip current protection elements, such as a current limiter or a fuse resulting in poor user experience. In some examples, some systems may attempt to accommodate for inrush current by increasing hardware capability to handle higher current draw, including an overcurrent trip that includes an auto-reset or auto restart, and/or locking current at an upper limit.

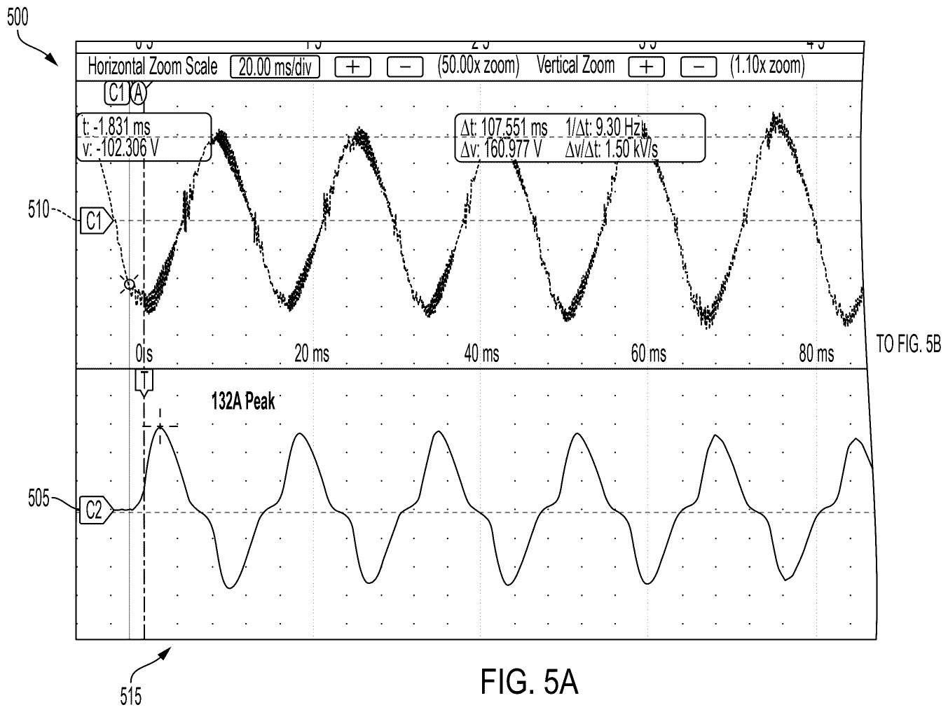

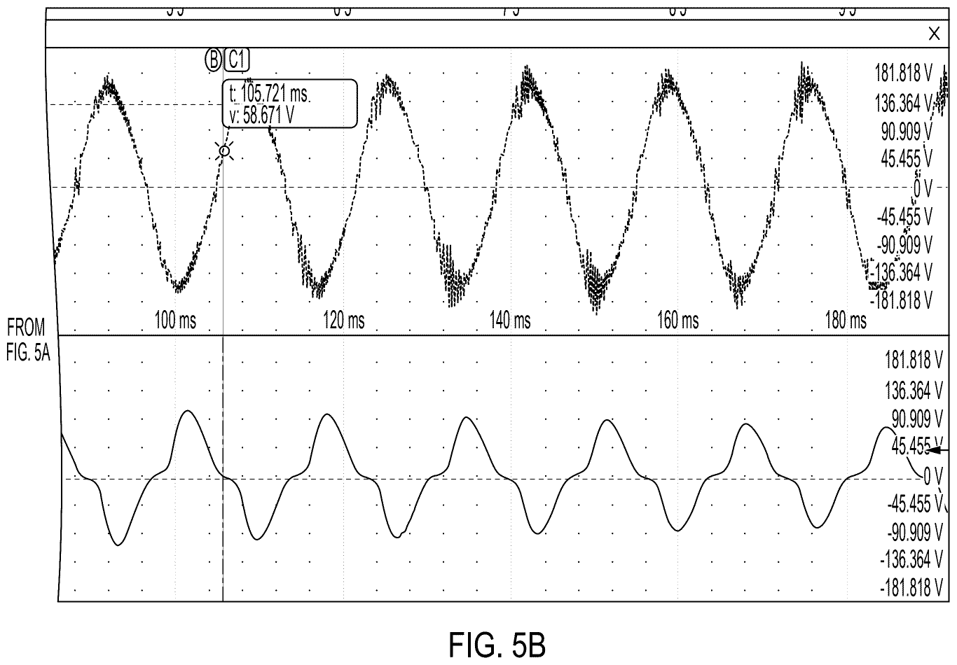

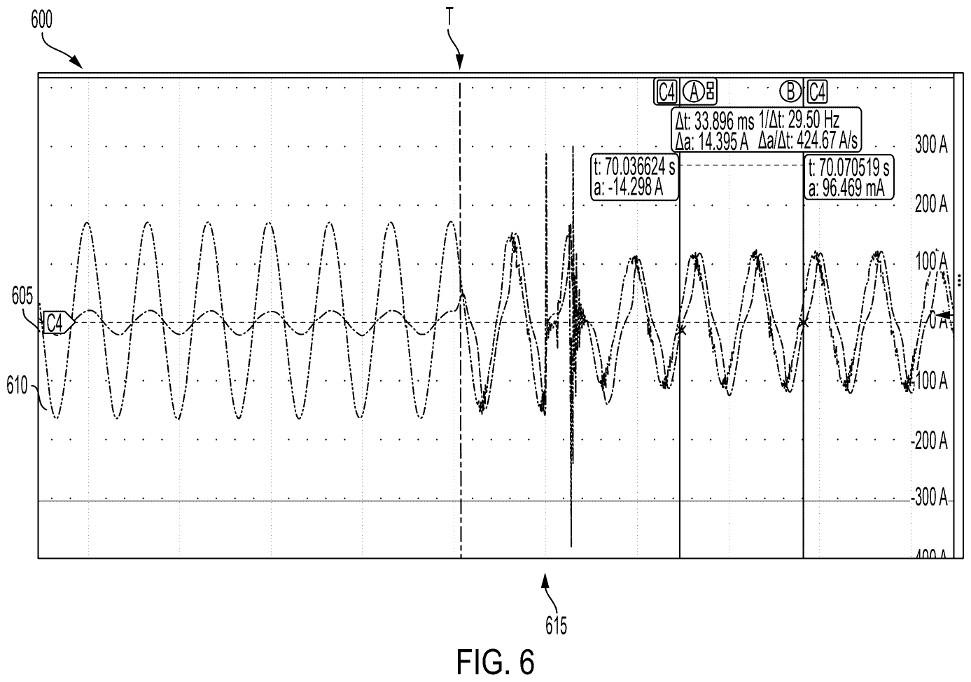

FIGS. 5A and 5B illustrate a graph 500 of a voltage and current during an operation of the electronic device 100 when the hardware capability is increased to handle higher current. Similar to previously described graph 400, the graph 500 includes a load current 505 and a voltage 510 trace illustrated on the graph 500. The load current 505 includes a peak current 515 of approximately 132 Amps. Increasing the hardware capability to handle such high currents increases costs. FIG. 6 illustrates a graph 600 of a voltage and current during an operation of the electronic device 100 with an auto-restart feature. The graph 600 illustrates an example where a second higher load is connected while a first load is already connected to the electronic device 100. In the graph 600, there is a non-zero load current 605 trace alongside the voltage 610 trace, illustrating an example where a non-zero load may be drawing power before the introduction of high inrush current. At approximately time T, the second higher load is connected, resulting in the current and voltage response illustrated. As the second higher load is initialized, the voltage drops and the current spikes. These events may cause the electronic device 100 to experience unwanted performance drops, slowing down operation, or may exceed a preset threshold, causing the tool to stop. For instance, a miter saw may include a compressor that draws a low amount of current (e.g., a non-zero load) from the electronic device 100 before operation of the miter saw begins. When the current limit is exceeded due to high current draw, the electronic device 100 may perform an auto-restart at 615. However, this auto-restart may result in choppy power output and also extends the startup time of the power tool resulting in poor user experience.

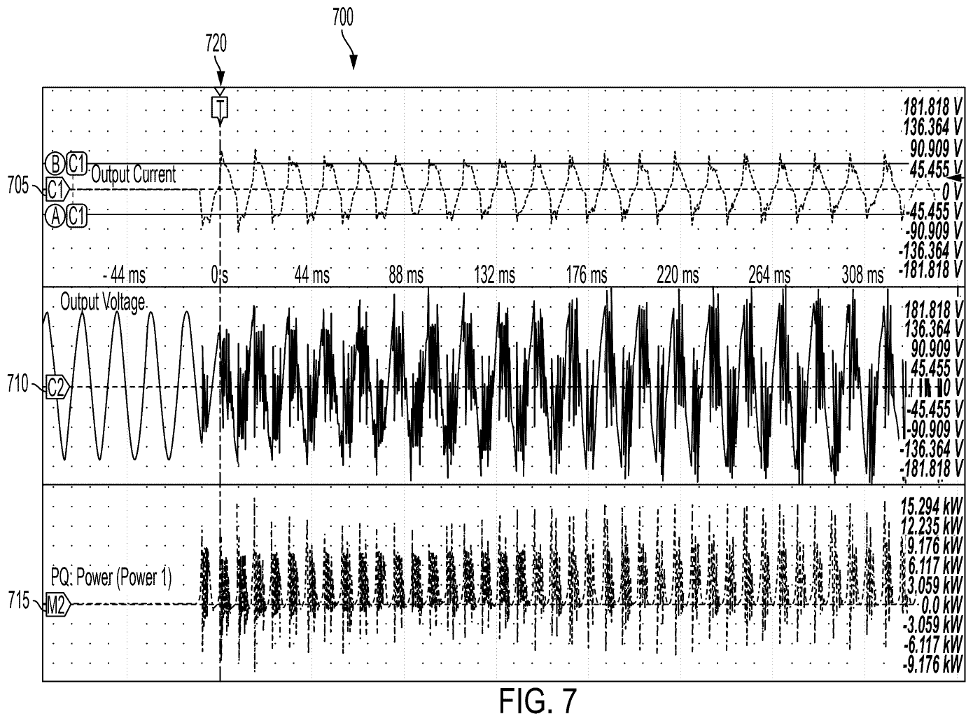

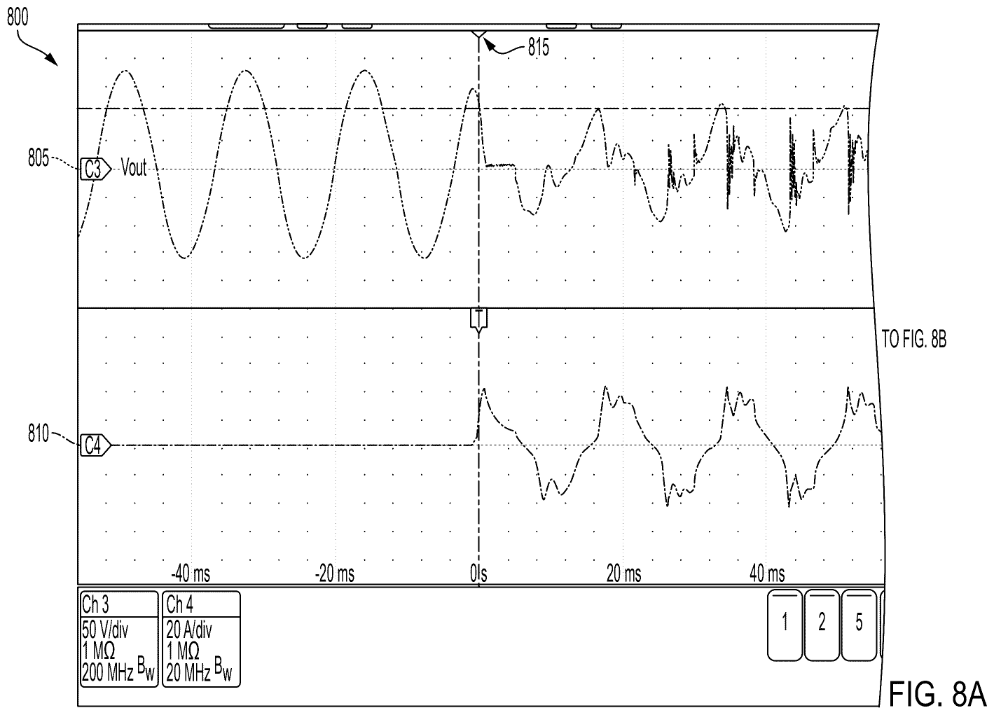

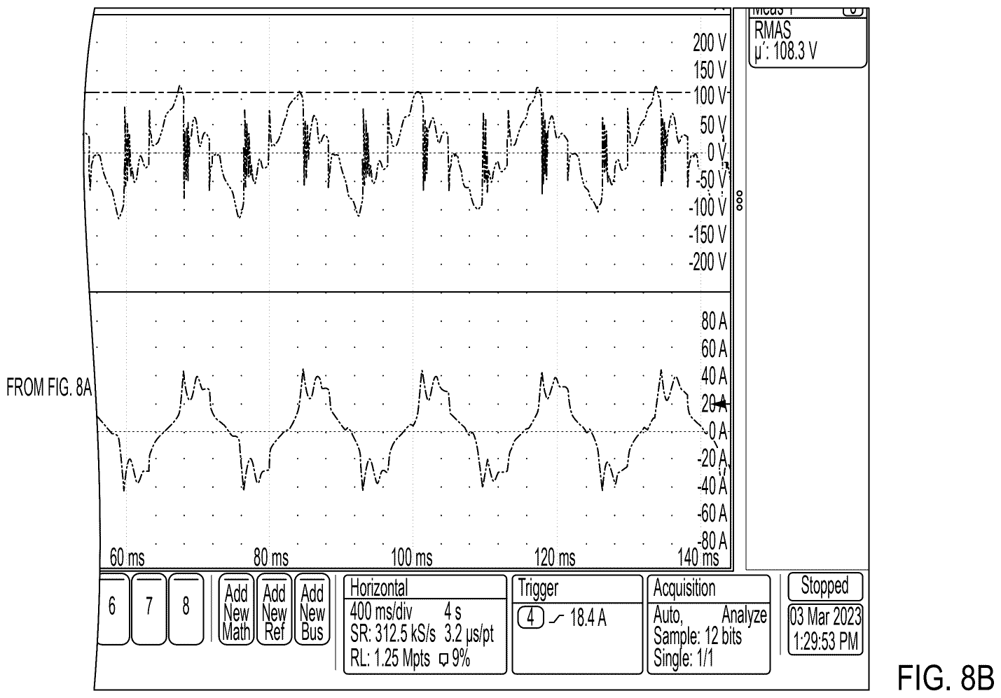

FIG. 7 illustrates a graph 700 of a voltage and current during an operation of the electronic device 100 when the upper limit of current is locked (e.g., at 58 Amperes). The graph 700 illustrates traces of an output current 705, an output voltage 710, and an output power 715. As illustrated, when the connected load (e.g., miter saw) begins operation, the output current 705 spikes and the output voltage 710 drops (at time T 720). At T 720, current limiting is initiated to limit the upper limit of the current. As illustrated in the graph 700, this results in high distortion of the voltage and power output at T 720. FIGS. 8A and 8B illustrate a graph 800 of output voltages and currents during an operation of the electronic device 100 when the upper limit of current is locked (e.g., at 30 Amperes), according to some embodiments. The graph 800 includes an output voltage 805 and an output current 810. At time T 815, the output voltage 805 dips significantly as the output current 810 is limited to prevent current spikes. The resultant output power is distorted resulting in poor user experience.

By using the current limit-based voltage foldback control systems and methods described herein, these high current spikes may be mitigated, reduced, or eliminated entirely. Additional techniques may be employed to mitigate the effects of high voltage distortion caused by the inrush currents illustrated and described above. In some examples, a soft start can gradually increase the voltage applied to the motor during starting, reducing the inrush current and any associated voltage distortion. In some examples, harmonic filters may help reduce the presence of unwanted harmonics, thus reducing voltage distortion.

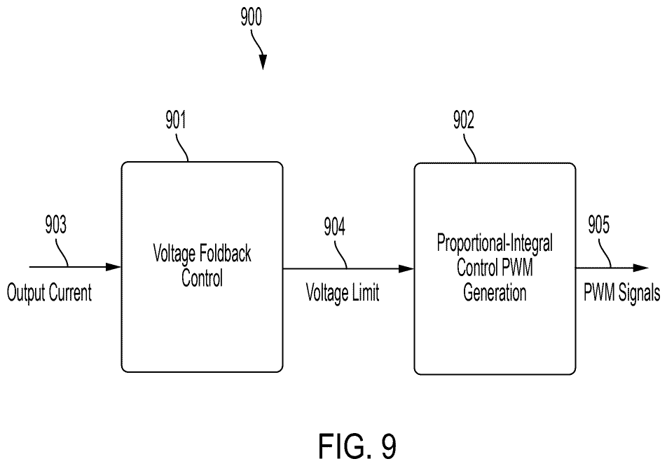

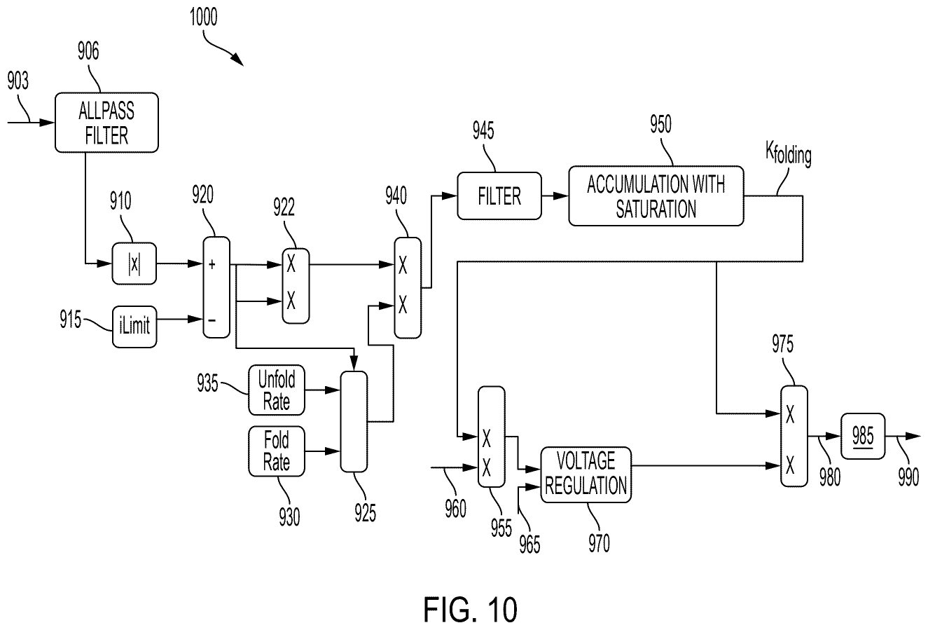

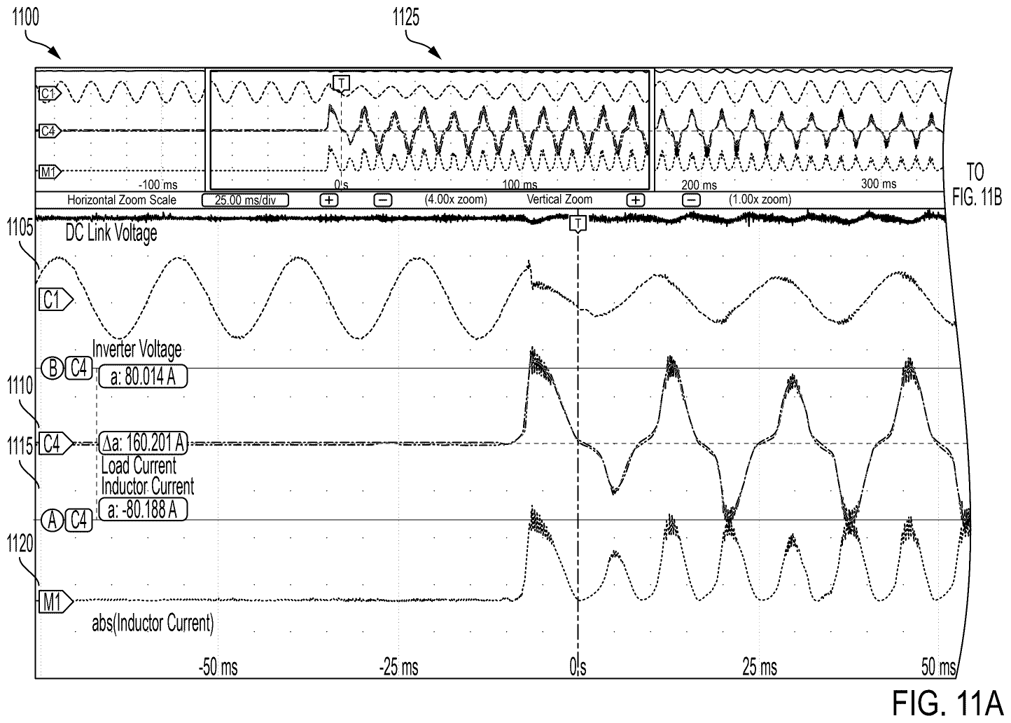

FIG. 9 is a block diagram illustrating an example control system 900. The control system 900 may be implemented or controlled by the controller 305 for current limiting based voltage foldback. The control system 900 includes a voltage foldback control block 901 (also referred to as a system or a control system) and a proportional-integral control PWM generation block 902. The voltage foldback control block 901 folds and unfolds a voltage limit of the power output. The voltage foldback control block 901 receives an output current 903 from the current sensor, such as sensors 360 previously described. The voltage foldback control block 901 generates a voltage limit 904 based on the output current 903 as described below with respect to FIG. 10. The proportional-integral control PWM generation block 902 receives the voltage limit 904 from the voltage foldback control block 901 and generates PWM signals 905 to control the power switching network 200 based on the voltage limit 904. In some examples, the voltage foldback control block 901 generates the control signals to control the gate driver 365 to generate the PWM signals. The power switching network 200 is controlled such that the output voltage at the power output does not exceed the voltage limit 904.

FIG. 10 is a block diagram of an example voltage foldback control system 1000 implemented by the voltage foldback control block 901 and the proportional-integral control PWM generation block 902. The voltage foldback control system 1000 may be implemented in hardware, software, or a combination of the two. The voltage foldback control system 1000 provides a voltage limit for controlling the power switching network 200. The voltage foldback control system 1000 performs foldback (e.g., folding, fold, or fold down) or unfolding (e.g., unfold or fold up) of the upper voltage limit at the power output based on the output current. In some examples, the control system 1000 continuously monitors the output current. When the output current exceeds a predetermined current threshold, the control system 1000 responds by reducing the voltage limit (i.e., folds). If the current continues to stay above the predetermined current threshold, the voltage limit is progressively reduced at a fold rate.

When the output current returns below the predetermined threshold, the control system 1000 unfolds the voltage limit at an unfold rate until a maximum voltage limit of the electronic device 100. In contrast to folding down, unfolding refers to the process of restoring the voltage limit to its normal value at an unfold rate when the output current continues to be below the predetermined current threshold. This allows the electronic device 100 to quickly resume normal operation and deliver optimum power to the load.

In the example illustrated, the control system 1000 includes a direct quadrature (dq) transform block 906 that receives the output current 903. The dq transform block 906 may be implemented using, for example, an all-pass filter. In some examples, output current 903 is the real-time current value of the power output provided to the load. In other example, the output current 903 is the current output from the power source 205. The dq transform block 906 is configured to introduce a frequency-dependent phase shift on the output current 903. For example, the dq transform block 906 performs a direct-quadrature (dq) zero transformation on the signal to convert an input AC signal to an output DC signal. In instances where dq transform block 906 performs dq transformations, the AC qualities of the input signal become constant (i.e., DC) values in steady-state conditions.

The control system 1000 determines an absolute value of the transformed output current at block 910. At block 920, the control system compares the absolute value of the output current to a current limit 915 (for example, compare the output current to a predetermined current threshold). In one example, the current limit 915 may be preset to the electronic device 100 and stored in the memory 330. In another example, the current limit 915 may be user configurable. At block 920, the control system 1000 determines the difference between the output current 903 and current limit 915 from the output current 903. The difference between the output current 903 is provided to the product block 922 and the selection block 925. The product block 922 squares the difference between the output current 903 and the current limit 915 to generate a squared difference.

The selection block 925 receives the difference between the output current 903 and the current limit 915 and uses the difference as a selection signal to select one of a fold rate 930 and an unfold rate 935 as the modification rate to modify the voltage limit. In some examples, the selection block 925 may be implemented as a multiplexor. The fold rate 930 and the unfold rate 935 may be preset into the electronic device 100 and stored in the memory 330. In some examples, the fold rate 930 and the unfold rate 935 may be user selectable. When the difference between the output current 903 and the current limit 915 is greater than zero (i.e., positive), then a fold rate 930 is selected as the modification rate. On the other hand, when the difference between the output current 903 and the current limit 915 is less than or equal zero (i.e., zero or negative), the unfold rate 935 is selected as the modification rate. In some examples, the fold rate 930 and the unfold rate 935 are asymmetric (i.e., unequal) in order to provide for a faster response time in one direction. For instance, asymmetrical modification rates refer to situations where the folding and unfolding processes occur at a different speed. This asymmetry might fold the voltage quickly but unfold it more slowly, or vice versa, depending on the output current 903. In some examples, a faster folding rate might be used to quickly reduce high voltage spikes, such as those previously described. A slower unfolding rate may be employed to control the voltage more carefully, reducing ripple effects.

Product block 940 (e.g., second product block) determines a scaling factor by multiplying the squared difference from product block 922 and the selected modification rate. That is, the squared difference between the output current 903 and the current limit 915 is multiplied by the selected one of the fold rate 930 and the unfold rate 935. The scaling factor is filtered using a filtering block 945 and an accumulation and saturation block 950. In one example, the filtering is performed using the Equation 1 (Eq1) below.

$$min ( x [ n ] , \frac{x [ n ] + x [ n - 1 ]}{2} ) \qquad ( Eq 1 )$$

In some examples, the filtering block 945 and the accumulation and saturation block 950 limit the unfolding due to noise. Once filtering is complete and any undesired unfolding due to noise is minimized, the accumulation and saturation block 950 outputs a scaling factor (K_{folding}) that ranges between 100% and 0%, where 100% is no folding and 0% is full folding. The K_{folding} factor may be applied to both the input and the output of the proportional-integral control PWM generation block 902 to provide fast response at the power output. The product block 955 (e.g., a third product block) receives the K_{folding} factor and a reference voltage 960. The reference voltage 960 may represent the maximum voltage limit for the power output of the electronic device 100. The product block 955 performs a multiplication operation between the K_{folding} factor and the reference voltage 960. For example, when the scaling factor K_{folding}=0.5, the product block 955 multiples the reference voltage 960 by the scaling foldback factor of 0.5 to output the voltage limit. The above provides one example method for determining a voltage of limit as a function of the difference between the output current 903 and the current limit 915.

A voltage regulator block 970 receives the voltage limit and a measured voltage 965 of the power output of the electronic device 100. The voltage regulator block 970 may determine an error rate between the voltage limit and the measured voltage. The error rate is passed to product block 975 (e.g., fourth product block), along with the K_{folding} factor. The control signal 980 is determined based on the product between the K_{folding} factor and the error signal and used to generate the PWM control signals 990 using the voltage control block 985.

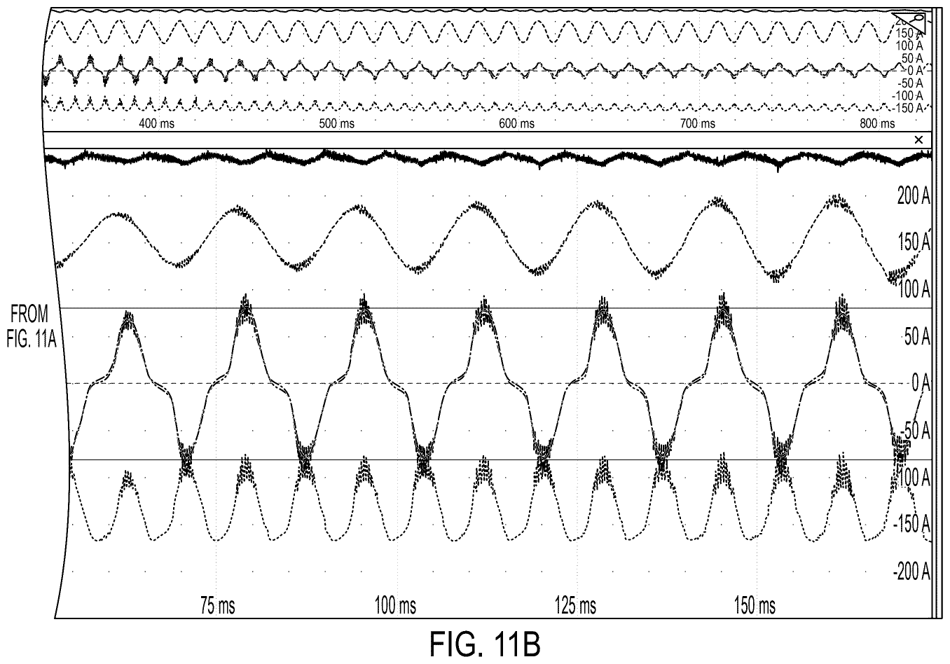

FIGS. 11A and 11B illustrate a graph 1100 of voltage and current during an operation of the electronic device 100 using the control system 1000 as previously described. The graph 1100 includes a power switching network voltage 1105, a load current 1110, an inductor current 1115, and an absolute inductor current 1120 as traced over time during startup operation. In some examples, the graph 1100 illustrates an electronic device 100 using the control system 1000 to modify the voltage limit of the power output. As illustrated in the graph, at time T 1125, the electronic device experiences start up conditions and the load current 1110 and the inductor current 1115 are stabilized based on modifying the voltage limit. The load current 1110 and the inductor current 1115 do not experience any undesired spiking and chatter. As illustrated in the graph 1100, the control system 1000 allows for a rapid increase in current and the foldback operations of the control system 1000 provides the target current without any undesired chatter. Although the example illustrated in the graph 1100 shows a current limit-based voltage foldback operation, it should be understood that similar approaches may provide for other limits. For example, a battery voltage-based voltage foldback may be implemented to limit battery inverter power outputs to prevent battery undervoltage faults. Similarly, a battery current based voltage foldback may limit inverter output to prevent battery overcurrent faults.

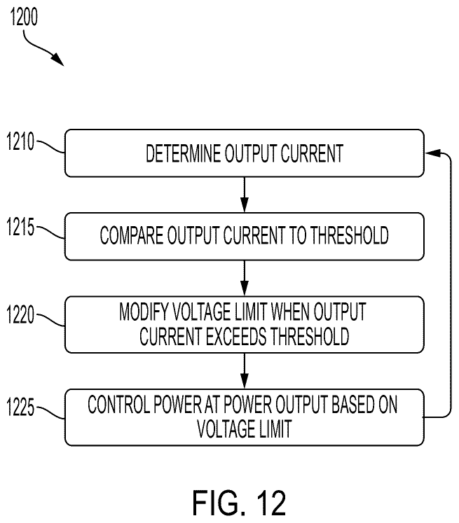

FIG. 12 is a flow chart illustrating an example method 1200 for current limit based voltage foldback. The method 1200 may be implemented using the controller 305 of the electronic device using the control system 1000. The method 1200 includes determining, using the current sensor, an output current (at block 1210). For example, as the electronic device 100 operates, the current of the load dynamically changes, as previously described and illustrated. This current may be measured by a current sensor, such as sensors 360.

The method 1200 includes comparing the output current to a predetermined current threshold (at block 1215). The controller may convert the AC current signal (e.g., sinusoidal signal) to a DC value (e.g., RMS) using, for example, by a dq transformation. The converted current may be compared to a preset current limit 915. That is, a difference between the output current 903 and the preset current limit 915 is determined at block 920 of FIG. 10. The method 1200 includes modifying a voltage limit of the power output when the output current exceeds the predetermined current threshold (at block 1220). When the controller 305 determines that the output current is greater than or equal to the predetermined current threshold, the controller 305 decreases the voltage limit of the power source. On the other hand, when the controller 305 determines that the output current is less than the predetermined current threshold, the controller may increase the voltage limit. The voltage limit is therefore determined based on or as a function of the difference between the output current 903 and the preset current limit 915.

The method includes controlling, using the power switching network 200, power provided at the power output based on the voltage limit (at block 1225). The controller 305 controls the power switching network 200 to provide power to the load within the voltage limit set based on the output current. As described above, the PWM generation block 902 receives the voltage limit and generates PWM signals to control the power switching network such that the output voltage does not exceed the voltage limit. Specifically, the output voltage may be controlled by changing the duty ratio as a function of the error between the output voltage and the voltage limit.

The current limit based voltage foldback as described above limits transient current for large startup loads of an inverter (for example, of a portable power supply, of a power tool, or the like).

Battery cells inherently include resistance that affects the flow of the direct-current (DC) current through the battery system. This resistance is referred to as the DC internal resistance (DCIR) of the battery system. DCIR may be affected by various conditions, e.g., environmental, age, state of charge, and the like. Specifically, DCIR is negatively affected at very low temperatures. That is, at very low temperatures (e.g., at −18 degrees Celsius), the DCIR is very high compared to normal operation conditions (e.g., at room temperature of 25 degrees Celsius). In these conditions, the output voltage of the battery system quickly collapses when connected to a large load and may trigger a battery system's end of discharge fault cutting off the output. This results in poor performance of the battery system and poor user experience due to constant shut offs before actual end of discharge.

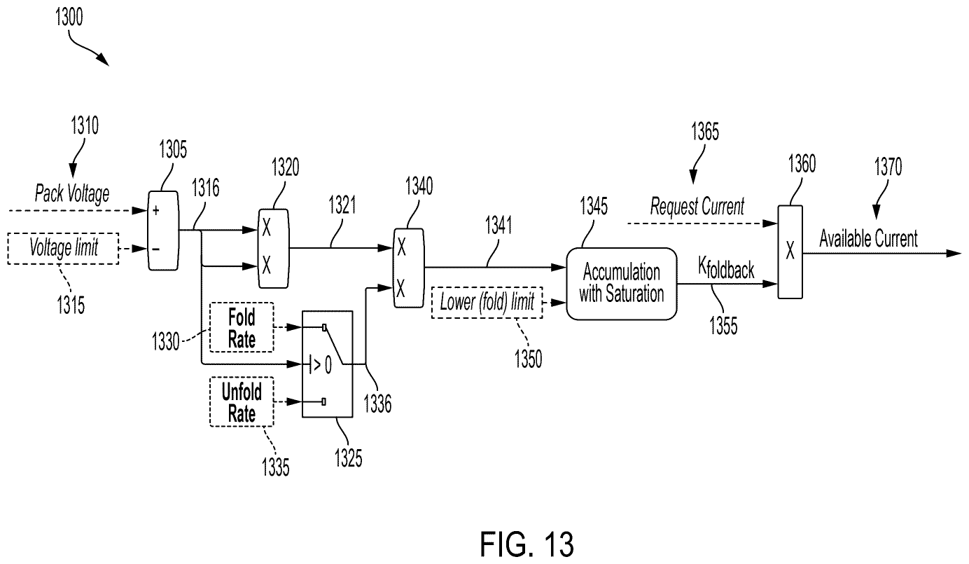

One way to address the above-noted problem is to use voltage limit based current foldback. FIG. 13 is a block diagram of an example current foldback control system 1300 (also referred to as the control system 1300). The control system 1300 may be implemented or controlled by the controller 305 for current foldback. The control system 1300 may perform foldback (e.g., folding, fold, or fold down) or unfolding (e.g., unfold or fold up) of a current limit for the system. In the example illustrated, the control system 1300 includes a voltage comparator block 1305. The voltage comparator block 1305 receives a battery voltage 1310 and a voltage limit 1315. The battery voltage is the voltage of the battery system (e.g., internal battery module 110 or battery packs 141, 142. The battery voltage may be detected using a voltage sensor and may denote a closed circuit voltage (CCV) of the battery system. In some examples, the battery voltage may be an open circuit voltage (OCV) of the battery system. The voltage limit 1315 may be a preset limit stored in a memory of the controller 305. In some examples, the voltage limit 1315 can be set by a user using an input mechanism of the electronic device 100. For example, the voltage limit 1315 may be set using a touch screen display on the electronic device 100 or using a smartphone application connected to the electronic device 100 using a wired or wireless connection. In some examples, the voltage limit 1315 is automatically adjusted based upon the type of connected powered electronic device. The voltage limit 1315 may be a threshold denoting a minimum voltage for optimum operation of the battery system as set by the manufacturer of the battery or based on tests conducted on the battery. As such, this denotes a lower limit for the battery system and is different from the voltage limit as determined in method 1200. The voltage comparator block 1305 determines the difference between the battery pack voltage 1310 and the voltage limit 1315. The voltage comparator block 1305 outputs a difference signal 1316 corresponding to the difference between the battery pack voltage 1310 and the voltage limit 1315. The voltage comparator block 1305 may be implemented as a differential amplifier, programmed into a hardware circuit (e.g., Field Programmable Gate Array—FPGA—, Application Specific Integrated Circuit—ASIC—, or the like), programmed in software, or the like.

The difference signal 1316 is provided to a product block 1320 (e.g., a first product block) and a selection block 1325. The product block 1320 squares the difference signal 1316 outputs a squared difference signal 1321. The product block 1320 may be implemented as an analog multiplier, programmed into a hardware circuit, programmed in software, or the like. The selection block 1325 receives the difference signal 1316 and uses the difference as a selection signal to select one of a fold rate 1330 and an unfold rate 1335. The selection block 1325 outputs one of the fold rate 1330 or the unfold rate 1335 as a modification rate 1336 based on the selection. The fold rate 1330 may be selected as the modification rate 1336 when the difference signal is greater (alternatively greater than or equal to) than zero, i.e., the battery voltage 1310 is greater than the voltage limit 1315. The unfold rate may be selected as the modification rate 1336 when the difference signal is less than or equal to (alternatively, simply less than) zero, i.e., the battery voltage is less than or equal to the voltage limit 1315. The fold rate 1330 is a rate at which (e.g., how quickly) the current folds down to maintain the voltage limit and the unfold rate 1335 is the rate at which the current folds up when the battery voltage 1310 is above the voltage limit. The fold rate 1330 and the unfold rate 1335 may be preset rates stored in a memory of the controller 305. In some examples, the fold rate 1330 and the unfold rate 1335 can be set by a user using an input mechanism of the electronic device 100. For example, the fold rate 1330 and the unfold rate 1335 may be set using a touch screen display on the electronic device 100 or using a smartphone application connected to the electronic device 100 using a wired or wireless connection. In some examples, the fold rate 1330 and the unfold rate 1335 are asymmetric (unequal), enabling a faster response time in one direction (i.e., when folding up or folding down). The selection block 1325 may be implemented as a multiplexor, programmed into a hardware circuit, programmed in software, or the like.

The squared difference signal 1321 and the modification rate 1336 are provided to a product block 1340 (e.g., a second product block). The product block multiplies the squared difference signal 1321 with the modification rate 1336 and outputs a modification signal 1341. An accumulation and saturation block 1345 receives the modification signal 1341 and a modification limit 1350. The accumulation and saturation block 1345 may filter and condition the modification signal 1341 and output a higher of the filtered modification signal 1341 and the modification limit 1350 as a modification factor 1355. The modification limit 1350 may be the minimum percentage of requested current allowed to be output. For example, a 60 Amp load may have a lower fold limit of 50%, for an output of 30 Amps. The modification factor 1355 (K_{foldback}, also referred to as a foldback factor) may ranges between 100% and 0%, where 100% is no folding and 0% is full folding. The modification factor 1355 is determined as a function of or based on the difference between the battery voltage 1310 and the voltage limit 1315 as described above.

The modification factor 1355 is provided to a product block 1360 (e.g., a third product block). The product block 1360 also receives a discharge current 1365. The product block 1360 multiplies the requested current with the modification factor 1355 and outputs an available current 1370. For example, when the modification factor 1355 value is 0.5 and the requested current is 60 Amps, the product block 955 multiples the requested current by the modification factor 1355 of 0.5 to output a current limit of 30 Amps. In one example, the discharge current 1365 is a current requested (e.g., request current) by a powered electronic device or determined by the controller 305 based on the requirements (or power draw) of the powered electronic device. In another example, the discharge current 1365 is a designed discharge current of the battery system, for example, a maximum allowable current, an optimal allowable current, or the like. In some examples, the controller 305 may switch between using the requested current and the designed discharge current as the discharge current 1365 based on various operating conditions of the electronic device. When a requested current is not available to scale from, for example, due to extremely low temperatures, the controller 305 may use the designed discharge current as the discharge current 1365. The control system 1300 as described above is only an example schematic illustration. The control system 1300 may be varied to perform current foldback method as described below. Additionally, the control system 1300 may be implemented as a hardware system with hardware components or digital circuits, programmed onto an FPGA or ASIC, or programmed in software and implemented by an electronic processor.

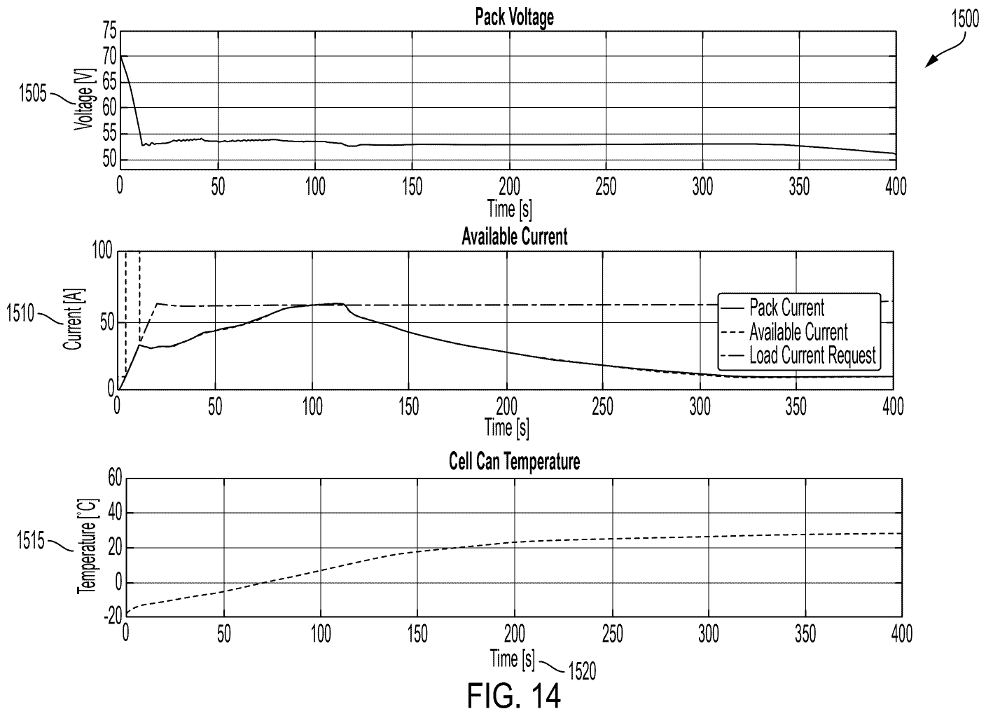

FIGS. 14-17 illustrate the performance of the current foldback under various operating conditions. FIG. 14 is a graph 1500 of simulation results for current foldback using a battery pack having a 3P configuration, having a state of charge of 30%, at a temperature of −18 degrees Celsius, and a requested current of 60 Amperes (A). 3P configuration corresponds to 3 strings of cells connected in parallel, each string included series connected cells (e.g., 10 series connected cells per string). The graph 1500 illustrates battery pack voltage 1505, available current 1510, and battery cell temperature 1515 over time 1520. The battery cell temperature 1515 as referred to herein is a temperature of the cell can of the battery cell. For example, a temperature sensor may be placed in contact or near the cell can of the battery cell to determine the temperature of the cell can or the battery cell. In some examples, the battery cells may each have different voltages. For example, one of the battery cells within a string may have a voltage of 2.7 volts and another battery cell within the string may have a voltage of 3.3 volts.

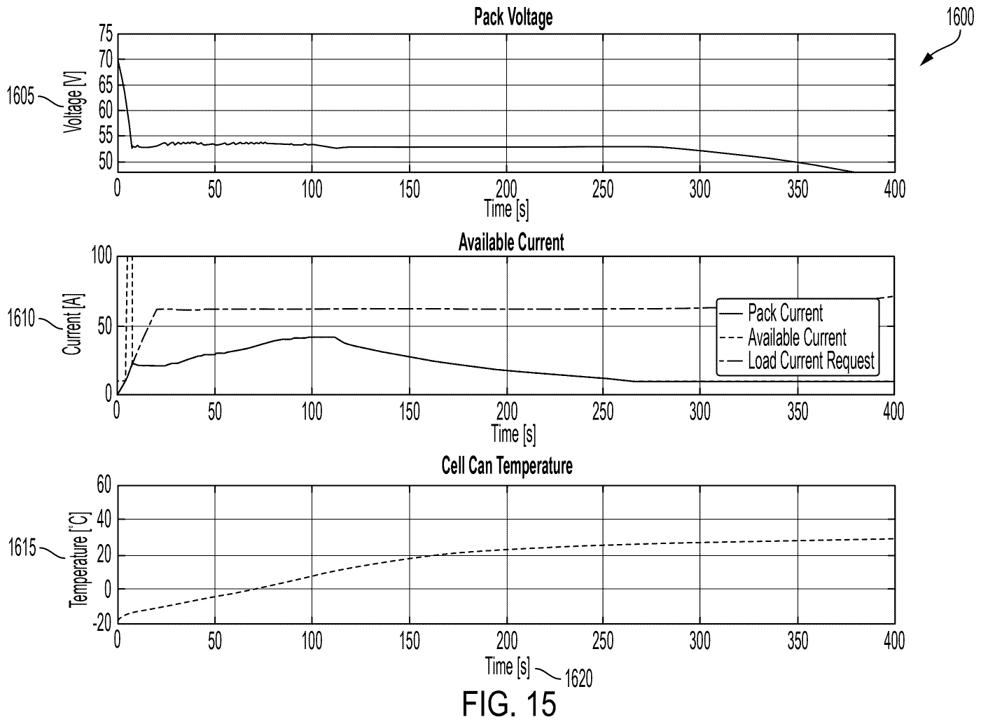

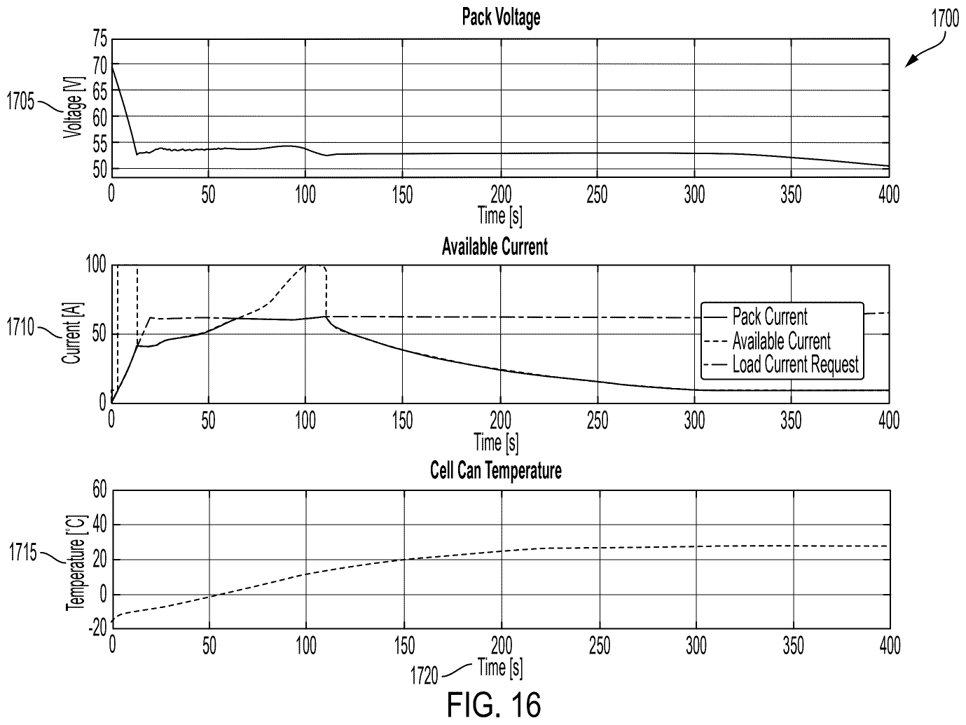

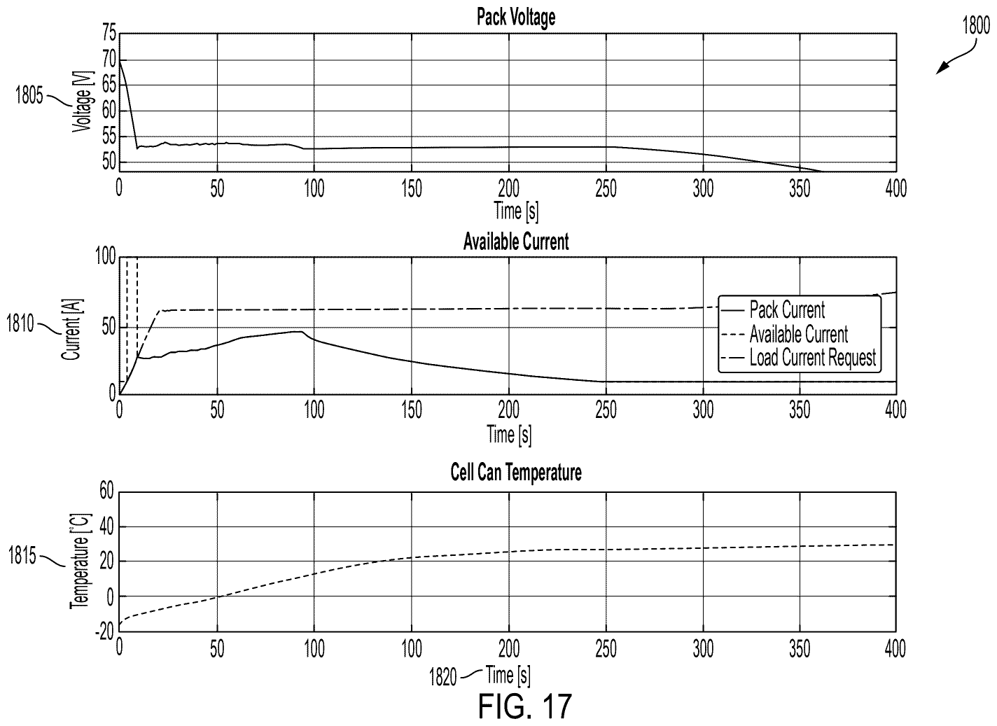

FIG. 15 is a graph 1600 of simulation results for current foldback using a battery pack having a 2P configuration, having a state of charge of 30%, at a temperature of-18 degrees Celsius, and a requested current of 60 A. Similar to graph 1500, graph 1600 illustrates battery pack voltage 1605, available current 1610, and battery cell temperature 1615 over time 1620. FIG. 16 is a graph 1700 of simulation results for current foldback using a battery pack having a 3P configuration, having a state of charge of 30%, at a temperature of-15 degrees Celsius, and a requested current of 60 A. Similar to graphs 1500, 1600, graph 1700 illustrates battery pack voltage 1705, available current 1710, and battery cell temperature 1715 over time 1720. FIG. 17 is a graph 1800 of simulation result for current foldback using a battery pack having a 2P configuration, having a state of charge of 30%, at a temperature of −15 degrees Celsius, and a requested current of 60 A. Similar to graphs 1500, 1600, 1700, graph 1800 illustrates battery pack voltage 1805, available current 1810, and battery cell temperature 1815 over time 1820. As illustrated in the graphs 1500, 1600, 1700, 1800, the current foldback performance generally provides a faster temperature heating response (e.g., heating of the battery pack cell cans) and provides an available current faster than alternative methods. By tuning the foldback and voltage limits as inputs to the control system 1300, the control system 1300 can be optimized for a range of cold temperature conditions.

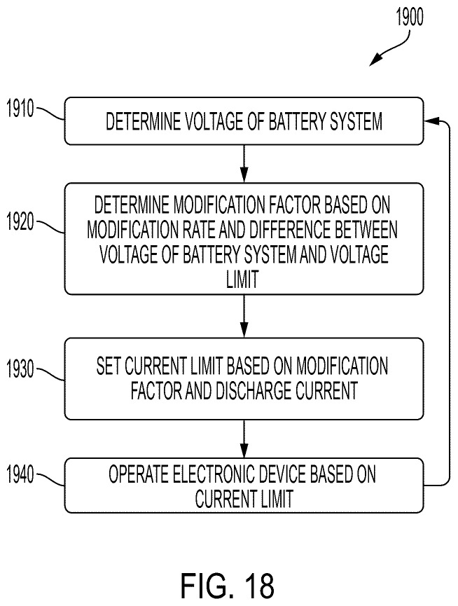

FIG. 18 is a flow chart illustrating an example method 1900 for current foldback. The method 1900 may be implemented by the controller 305 of the electronic device using the control system 1300. The method 1900 includes determining, using the controller 305, a voltage of the battery system (at block 1910). In some examples, the voltage sensors are provided in the electronic device 100. In other examples, the battery system may communicate the voltage of the battery system to the electronic device 100. The voltage of the battery system may refer to the stack voltage of the battery system, e.g., the voltage across the cell strings of the battery system.

The method 1900 includes determining, using the controller 305, a modification factor based on a modification rate and a difference between the voltage of the battery system and a voltage limit (at block 1920). The controller 305 determines a difference between the voltage of the battery system and the voltage limit (e.g., the difference signal). In some examples, the modification rate is selected as one of the fold rate or the unfold rate based on the difference signal. In other examples, an unfold rate may not be used and the modification rate is always set to the fold rate. In this example, when the difference signal is zero, the product of the modification rate and the difference signal is also zero resulting in no fold up. The difference signal is then multiplied by the modification rate to output the modification rate.

The method 1900 includes setting, using the controller 305, a current limit based on the modification factor and a discharge current (at block 1930). The discharge current is, for example, a request current of the electronic device based on the connected powered electronic device (i.e., a device drawing power from the power output 215). The discharge current may also be a designed discharge current for the battery system or electronic device that may be preset into the controller 305. In some examples, the discharge current may be set to one of the request current or designed discharge current based on the temperature of the battery system. For example, the designed discharge current may be used as the discharge current below a temperature threshold (e.g., −15 degrees Celsius) and the requested current may be used above the temperature threshold. In some examples, the modification factor may be conditioned and filtered (e.g., using an accumulation and saturation block 1345. The current limit is determined by multiplying the modification factor with the discharge current.

The method 1900 includes operating, using the controller 305, the electronic device based on the current limit (at block 1940). The controller 305 may use the current limit to limit the output current of the electronic device. For example, the controller 305 may control the power switching network 200 (e.g., inverter) to not exceed the current limit. That is, the controller 305 may control the power switching network 200 to output the current limit even when the requested current or discharge current is higher than the current limit.

The current foldback methods and techniques as described herein provide superior performance, for example, compared to an alternative method when operating the electronic device 100 at very low temperatures. In general, it should be understood that while systems and methods herein describe regulation of battery pack voltage, similar regulation may be performed specifically with respect to an individual battery cell within the battery pack. For example, the methods described herein may determine the voltage of a particular battery cell within the battery system and control the charging/discharging of that battery cell or the battery pack. Similarly, the systems and methods herein may control multiple cells within a battery system independently with respect to one another, such that the charging/discharging of each battery cell is individually regulated.

Although the disclosure has been described in detail with reference to certain preferred embodiments, variations and modifications exist within the scope and spirit of one or more independent aspects of the disclosure as described. Various features and advantages are set forth in the following claims.

What is claimed is:

1. An electronic device comprising:
a power output;
a power source;
a power switching network electrically connected between the power source and the power output;
a current sensor configured to measure an output current provided at the power output; and
a controller electrically connected to the current sensor and the power switching network, the controller configured to:
determine, using the current sensor, the output current,
compare the output current to a predetermined current threshold,
determine a voltage limit at the power output as a function of a difference between the output current and the predetermined current threshold, and
control, using the power switching network, power provided at the power output based on the voltage limit.

2. The electronic device of claim 1, wherein the controller is configured to fold the voltage limit at a predetermined fold rate when the output current is greater than or equal to the predetermined current threshold.

3. The electronic device of claim 2, wherein the controller is configured to unfold the voltage limit at a predetermined unfold rate when the voltage limit is below a maximum voltage limit for the electronic device and the output current is less than the predetermined current threshold.

4. The electronic device of claim 3, wherein the predetermined fold rate and the predetermined unfold rate are asymmetric.

5. A method for voltage foldback in an electronic device, the method comprising:
determining, using a current sensor of the electronic device, an output current at a power output of the electronic device;
comparing, using a controller of the electronic device, the output current to a predetermined current threshold;
determining, using the controller, a voltage limit at the power output as a function of a difference between the output current and the predetermined current threshold, and controlling, using a power switching network connected between s power source and the power output of the electronic device, power provided at the power output based on the voltage limit.

6. The method of claim 5, wherein determining the voltage limit further comprises folding the voltage limit at a predetermined fold rate when the output current is greater than or equal to the predetermined current threshold.

7. The method of claim 6, wherein determining the voltage limit further comprises unfolding the voltage limit at a predetermined unfold rate when the voltage limit is below a maximum voltage limit for the electronic device and the output current is less than the predetermined current threshold.

8. The method of claim 7, wherein the predetermined fold rate and the predetermined unfold rate are asymmetric.

9. An electronic device comprising:
a battery system; and
a controller electrically connected to the battery system and configured to:
determine a voltage of the battery system,
determine a modification factor based on a modification rate and a difference between the voltage and a voltage limit,
set a current limit based on the modification factor and a discharge current, and
operate the electronic device based on the current limit.

10. The electronic device of claim 9, wherein the controller is further configured to:
receive a requested current,
determine a temperature of the battery system,
set the requested current as the discharge current when the temperature is above a temperature threshold, and
set a designed discharge current as the discharge current when the temperature is below the temperature threshold.

11. The electronic device of claim 9, wherein the controller is further configured to:
set a fold rate as the modification rate when the difference between the voltage and the voltage limit is greater than zero, and
set an unfold rate as the modification rate when the difference between the voltage and the voltage limit is less than or equal to zero.

12. The electronic device of claim 11, wherein the fold rate and the unfold rate are asymmetric.

13. The electronic device of claim 9, wherein the controller is further configured to set the modification factor to higher of a modification limit and a product of the modification rate and the difference between the voltage and the voltage limit.

14. The electronic device of claim 9, wherein the battery system comprises a plurality of battery cells, and wherein the voltage is a voltage of at least one battery cell of the plurality of battery cells.

15. A method for current foldback in an electronic device, the method comprising:
determining, using a controller of the electronic device, a voltage of a battery system of the electronic device,
determining, using the controller, a modification factor based on a modification rate and a difference between the voltage and a voltage limit,
setting, using the controller, a current limit based on the modification factor and a discharge current, and
operating, using the controller, the electronic device based on the current limit.

16. The method of claim 15, further comprising:
receiving, using the controller, a requested current,
determining, using the controller, a temperature of the battery system,
setting, using the controller, the requested current as the discharge current when the temperature is above a temperature threshold, and
setting using the controller, a designed discharge current as the discharge current when the temperature is below the temperature threshold.

17. The method of claim 15, further comprising:
setting, using the controller, a fold rate as the modification rate when the difference between the voltage and the voltage limit is greater than zero, and
setting, using the controller, an unfold rate as the modification rate when the difference between the voltage and the voltage limit is less than or equal to zero.

18. The method of claim 17, wherein the fold rate and the unfold rate are asymmetric.

19. The method of claim 15, further comprising setting, using the controller, the modification factor to higher of a modification limit and a product of the modification rate and the difference between the voltage and the voltage limit.

20. The method of claim 15, wherein the battery system comprises a plurality of battery cells, and wherein the voltage is a voltage of at least one battery cell of the plurality of battery cells.
